(19) United States
(12) Patent Application Publication
(10) Pub. No.: US 2022/0413494 A1
(43) Pub. Date: Dec. 29, 2022

(54) AUTONOMOUS VEHICLE, CONTROL SYSTEM FOR REMOTELY CONTROLLING THE SAME, AND METHOD THEREOF

(71) Applicants: Hyundai Motor Company, Seoul (KR); Kia Corporation, Seoul (KR)

(72) Inventor: Dong Hyuk KIM, Hanam-Si (KR)

(73) Assignees: Hyundai Motor Company, Seoul (KR); Kia Corporation, Seoul (KR)

(21) Appl. No.: 17/545,960

(22) Filed: Dec. 8, 2021

(30) Foreign Application Priority Data
Jun. 25, 2021 (KR) 10-2021-0083399

(51) Int. Cl. G05D 1/00; G05D 1/02; G07C 5/08; G07C 5/00

(52) U.S. Cl. CPC G05D 1/0044; G05D 1/0038; G05D 1/0061; G05D 1/0214; G05D 1/0238; G05D 1/0246; G07C 5/0808; G07C 5/008

(57) ABSTRACT

An autonomous vehicle may include an autonomous driving control apparatus including a processor that is configured to request remote control of the autonomous vehicle to a control system when remote control of the autonomous vehicle is required, when receiving a remote control path and a remote control command from the control system, determines whether the remote control path and the remote control command match, and performs the remote control command depending on a result thereof.

### CROSS-REFERENCE TO RELATED APPLICATION

The present application claims priority to Korean Patent Application No. 10-2021-0083399, filed on Jun. 25, 2021, the entire contents of which is incorporated herein for all purposes by this reference.

### BACKGROUND OF THE INVENTION

### Field of the Invention

The present invention relates to an autonomous vehicle, a control system for remotely controlling the same, and a method thereof, and more particularly, to a technique for minimizing a path setting error in a remote control situation of an autonomous vehicle.

### Description of Related Art

As an electronic technique of a vehicle develops, an interest in an autonomous vehicle that drives to a destination by recognizing a driving environment of the vehicle itself without manipulation of a driver is growing more and more.

An autonomous vehicle refers to a vehicle capable of operating by itself without manipulation of a driver or a passenger.

While driving in an autonomous driving mode, there may be a situation in which it is impossible to follow a driving path to the destination normally although there is no abnormality in a function of the vehicle. Accordingly, when a situation where it is impossible to follow a path occurs during autonomous driving, it is often difficult to follow the driving path, such as when the driver directly intervenes in control of the vehicle or when the driver's intervention is difficult, the vehicle stops.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing an autonomous vehicle, a control system for remotely controlling the same, and a method thereof, configured for preventing a vehicle accident by minimizing an error of a remote control path setting by a control system.

The technical objects of the present invention are not limited to the objects mentioned above, and other technical objects not mentioned may be clearly understood by those skilled in the art from the description of the claims.

Various aspects of the present invention are directed to providing an autonomous vehicle, including an autonomous driving control apparatus including a processor that is configured to request remote control of the autonomous vehicle to a control system when remote control of the autonomous vehicle is required, when receiving a remote control command a remote control command from the control system, determines whether the remote control path and the remote control command match, and performs the remote control command depending on a result thereof.

In various exemplary embodiments of the present invention, the processor, when receiving a consent request for the remote control path from the control system, may transmit consent for the remote control path to the control system.

In various exemplary embodiments of the present invention, the autonomous vehicle may further include a display device configured to display the remote control path and a consent request screen for the remote control path.

In various exemplary embodiments of the present invention, the processor may follow and control the remote control command when a path by the remote control command received from the control system matches the remote control path.

In various exemplary embodiments of the present invention, the processor may request the remote control to the control system again without following and controlling the remote control command when the path by the remote control command received from the control system does not match the remote control path.

In various exemplary embodiments of the present invention, the processor, may transmit at least one of vehicle position information, vehicle surrounding image information, or vehicle surrounding information to the control system when requesting the remote control to the control system.

In various exemplary embodiments of the present invention, the autonomous vehicle may further include: a communication device configured to communicate with the control system; and a storage configured to store the remote control path received from the control system.

Various aspects of the present invention are directed to providing a control system including a processor configured to generate a remote control path for remote control of the autonomous vehicle when receiving a remote control request from the autonomous vehicle, to determine whether the remote control path is drivable based on a previous driving history of the remote control path, and when the processor determines that the remote control path is drivable, to transmit the remote control path and a remote control command to the autonomous vehicle.

In various exemplary embodiments of the present invention, the processor may generate the remote control path based on information received from the autonomous vehicle.

In various exemplary embodiments of the present invention, the processor may determine whether there is a driving history of a road on the remote control path on which a vehicle has previously driven.

In various exemplary embodiments of the present invention, the processor may collect the driving history of the road on the remote control path and driving histories of surrounding roads of the remote control path in advance from the vehicle, and the control system may further include a storage configured to store the collected driving histories.

In various exemplary embodiments of the present invention, the processor, may determine whether there is a history of a vehicle driving in a same direction as a driving direction on the remote control path when there is the driving history of the road on the remote control path on which the vehicle has previously driven.

In various exemplary embodiments of the present invention, the processor, when there is the history of the vehicle driving in the same direction as the driving direction on the remote control path, may determine the remote control path as a final remote control path to transmit the remote control path to the autonomous vehicle.

In various exemplary embodiments of the present invention, the processor, when there is a history of a vehicle driving in an opposite direction to the driving direction on the remote control path, may determine whether a vehicle speed of the vehicle driving in the opposite direction is greater than or equal to a predetermined reference value.

In various exemplary embodiments of the present invention, the processor, when the vehicle speed of the vehicle driving in the opposite direction is greater than or equal to the predetermined reference value, may request consent for the remote control path to the autonomous vehicle.

In various exemplary embodiments of the present invention, the processor, when receiving a consent request for the remote control path from the autonomous vehicle, may determine the remote control path as a final remote control path to transmit the remote control path to the autonomous vehicle.

In various exemplary embodiments of the present invention, the processor, when the vehicle speed of the vehicle driving in the opposite direction is smaller than the predetermined reference value, may determine the remote control path as a final remote control path to transmit the remote control path to the autonomous vehicle.

In various exemplary embodiments of the present invention, the processor, when the vehicle speed of the vehicle driving in the opposite direction is greater than or equal to the predetermined reference value, may receive approval for the remote control path from an expert.

In various exemplary embodiments of the present invention, the processor, may generates a remote control command based on information received when receiving a remote control request from the autonomous vehicle to transmit the remote control command to the autonomous vehicle in real time.

Various aspects of the present invention are directed to providing a remote control method for an autonomous vehicle, including: receiving a remote control request from the autonomous vehicle; generating a remote control path for the remote control request; determining whether the remote control path is drivable based on a previous driving history of the remote control path; transmitting the remote control path to the autonomous vehicle when the remote control path is drivable; and generating a remote control command for the remote control request to transmit the remote control command to the autonomous vehicle.

According to the present technique, it is possible to prevent a vehicle accident by minimizing an error of a remote control path setting by a control system, securing reliability of remote control and improving commercialization of autonomous driving.

Furthermore, various effects which may be directly or indirectly identified through the present specification may be provided.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a block diagram showing a configuration of a remote control system for an autonomous apparatus according to various exemplary embodiments of the present invention.

FIG. 2A illustrates a view for describing a sensing device of an autonomous vehicle according to various exemplary embodiments of the present invention.

FIG. 2B illustrates a sensing range of a sensing device of an autonomous vehicle according to various exemplary embodiments of the present invention.

FIG. 3 illustrates a view for describing a process of determining whether to request remote control of an autonomous vehicle according to various exemplary embodiments of the present invention.

FIG. 4 illustrates a view for describing an example of a screen which is displayed in a control system based on information received from an autonomous vehicle according to various exemplary embodiments of the present invention.

FIG. 5 illustrates an example of a screen showing a remote control path generated by a control system according to various exemplary embodiments of the present invention.

FIG. 6 illustrates a flowchart showing a remote control method for an autonomous vehicle according to various exemplary embodiments of the present invention.

FIG. 7 illustrates a computing system according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, some exemplary embodiments of the present invention will be described in detail with reference to exemplary drawings. It should be noted that in adding reference numerals to constituent elements of each drawing, the same constituent elements have the same reference numerals as possible even though they are indicated on different drawings. Furthermore, in describing exemplary embodiments of the present invention, when it is determined that detailed descriptions of related well-known configurations or functions interfere with understanding of the exemplary embodiments of the present invention, the detailed descriptions thereof will be omitted.

In describing constituent elements according to various exemplary embodiments of the present invention, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms have the same meanings as those which are generally understood by those skilled in the technical field to which various exemplary embodiments of the present invention pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

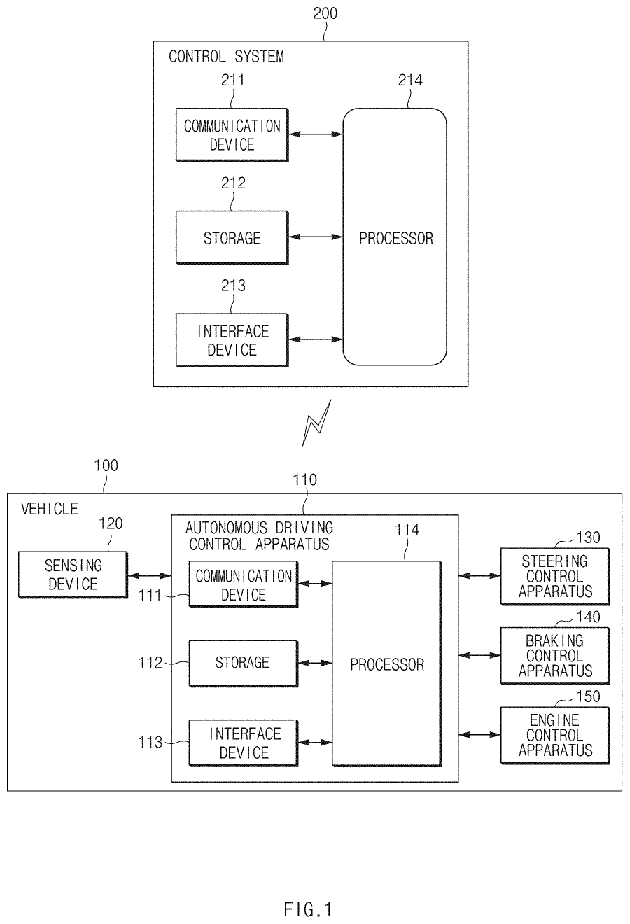

Hereinafter, various exemplary embodiments of the present invention will be described in detail with reference to FIG. 1 to FIG. 7.

FIG. 1 illustrates a block diagram showing a configuration of a remote control system for an autonomous apparatus according to various exemplary embodiments of the present invention.

Referring to FIG. 1, the remote control system for an autonomous vehicle according to various exemplary embodiments of the present invention includes a vehicle 100 and a control system 200, and remote control may be performed through communication between the vehicle 100 and the control system 200. In the instant case, the vehicle 100 may include an autonomous vehicle.

The vehicle 100 may include an autonomous driving control apparatus 120, a sensing device 120, a steering control apparatus 130, a braking control apparatus 140, and an engine control apparatus 150.

The autonomous driving control apparatus 110 according to the exemplary embodiment of the present invention may be implemented inside the vehicle. In the instant case, the autonomous driving control apparatus 110 may be integrally formed with internal control units of the vehicle, or may be implemented as a separate device to be connected to control units of the vehicle by a separate connection means.

When remote control of the autonomous vehicle required, the autonomous driving control apparatus 110 requests remote control to the control system 200. Furthermore, the autonomous driving control apparatus 110 receives and stores a remote control path for the remote control request from the control system 200, and when receiving a remote control command for the remote control request from the control system 200, determines whether the remote control path and the remote control command match, to determine whether the remote control command received from the control system 200 is in error. Accordingly, the autonomous driving control apparatus 110 may perform the remote control command when the remote control path and the remote control command match, and may request the remote control back to the control system 200 without performing the remote control command when the remote control path and remote control command do not match.

Referring to FIG. 1, the autonomous driving control apparatus 110 may include a communication device 111, a storage 112, an interface unit 113, and a processor 114.

The communication device 111 is a hardware device implemented with various electronic circuits to transmit and receive signals through a wireless or wired connection, and may transmit and receive information based on in-vehicle devices and in-vehicle network communication techniques. As an example, the in-vehicle network communication techniques may include controller area network (CAN) communication, Local Interconnect Network (LIN) communication, flex-ray communication, Ethernet communication, and the like.

Furthermore, the communication device 111 may perform communication by use of a server, infrastructure, or third vehicles outside the vehicle, and the like through a wireless Internet technique or short range communication technique. Herein, the wireless Internet technique may include wireless LAN (WLAN), wireless broadband (Wibro), Wi-Fi, Worldwide Interoperability for Microwave Access (WiMAX), Ethernet communication, etc. Furthermore, short-range communication technique may include Bluetooth, ZigBee, ultra wideband (UWB), radio frequency identification (RFID), infrared data association (IrDA), and the like. For example, the communication device 111 may perform wireless communication with the control system 200, may transmit vehicle position information (e.g., vehicle coordinates), surrounding information (e.g., obstacle information), vehicle information (e.g., overall length and width of a host vehicle), a remote control request, etc. To the control system 200, and may receive a remote control path, a consent request for the remote control path, a remote control command, and the like from the control system 200.

The storage 112 may store sensing results of the sensing device 120, information received from the control system 200, data and/or algorithms required for the processor 114 to operate, and the like.

As an example, the storage 112 may store vehicle information, a vehicle driving path, image data captured by a camera, and a remote control path received from the control system 200.

The storage 112 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 113 may include an input means for receiving a control command from a user and an output means for outputting an operation state of the autonomous driving control apparatus 110 and results thereof. Herein, the input means may include a key button, and may further include a mouse, a keyboard, a touch screen, a microphone, a joystick, a jog shuttle, a stylus pen, and the like. Furthermore, the input means may further include a soft key implemented on the display.

The output means may include a display, and may further include a voice output means such as a speaker. In the instant case, when a touch sensor formed of a touch film, a touch sheet, or a touch pad is provided on the display, the display may operate as a touch screen, and may be implemented in a form in which an input device and an output device are integrated.

In the instant case, the display may include at least one of a liquid crystal display (LCD), a thin film transistor liquid crystal display (TFT LCD), an organic light emitting diode display (OLED display), a flexible display, a field emission display (FED), or a 3D display.

As an example, the interface device 113 may be implemented as a head-up display (HUD), a cluster, an audio video navigation (AVN), a human machine interface (HM), a user setting menu (USM), or the like.

For example, the interface 113 may display the remote control path received from the control system 200, the consent request for the remote control path, and the remote control command.

Furthermore, the interface device 113 may receive a consent input from a driver on a consent request screen for the remote control path received from the control system 200. To the present end, the interface device 113 may receive the input from the driver through a mouse, a keyboard, a touch screen, a microphone, or the like.

The processor 114 may be electrically connected to the communication device 111, the storage 112, the interface device 113, and the like, may electrically control each component, and may be an electrical circuit that executes software commands, performing various data processing and determinations described below.

The processor 114 may process a signal transferred between components of the autonomous driving control apparatus 110, and may perform overall control such that each of the components can perform its function normally.

The processor 114 may be implemented in a form of hardware, software, or a combination of hardware and software, or may be implemented as microprocessor, and may be, e.g., an electronic control unit (ECU), a micro controller unit (MCU), or other subcontrollers mounted in the vehicle.

The processor 114 may determine a situation in which remote control of the autonomous vehicle is required. That is, the processor 114 may determine a situation in which the vehicle cannot travel on an existing path due to a driving situation or an emergency situation as a situation requiring the remote control, and may request remote control to the control system 200.

The processor 114 may transmit information for remote control of the autonomous vehicle when the remote control is requested to the control system 200. In the instant case, the information may include vehicle position information (e.g., vehicle coordinates), image information around the vehicle, information around the vehicle (e.g., obstacles, moving vehicle information, stationary vehicle information (fixed objects), map information, and the like.

The processor 114 may receive a remote control path and a remote control command for remote control from the control system 200, may compare the remote control path with the remote control command, and generate and follow a path based on the received remote control command depending on a result thereof. In the instant case, the remote control command may include at least one of ignoring a misrecognized object, changing a lane, ignoring a maximum road speed, ignoring a traffic signal, or responding to a hand signal.

That is, when the remote control of the autonomous vehicle is required, the processor 114 may request the remote control from the control system 200, and receive a remote control path from the control system 200, and when receiving a remote control command from the control system 200, may determine whether the remote control path and the remote control command match, and perform the remote control command depending on a result thereof.

When receiving a consent request for the remote control path from the control system 200, the processor 114 may display a consent request screen for the remote control path on the interface device 113 to receive a consent from the driver, to transmit the consent for the remote control path to the control system 200 through the communication device 111.

When a path by the remote control command received from the control system 200 matches the remote control path, the processor 114 may follow and control the remote control command.

On the other hand, when the path by the remote control command received from the control system 200 and the remote control path do not match, the processor 114 does not follow and control the remote control command, and may request the remote control to the control system 200 again.

The sensing device 120 may include one or more sensors that detect an obstacle, e.g., a preceding vehicle, positioned around the host vehicle and measure a distance with the obstacle and/or a relative speed thereof.

The sensing device 120 may include a plurality of sensors to detect an external object of the vehicle, to obtain information related to a position of the external object, a speed of the external object, a moving direction of the external object, and/or a type of the external object (e.g., vehicles, pedestrians, bicycles or motorcycles, etc.). To the present end, the sensing device 120 may include an ultrasonic sensor, a radar, a camera, a laser scanner, and/or a corner radar, a Light Detection and Ranging (LiDAR), an acceleration sensor, a yaw rate sensor, a torque measurement sensor and/or a wheel speed sensor, a steering angle sensor, etc.

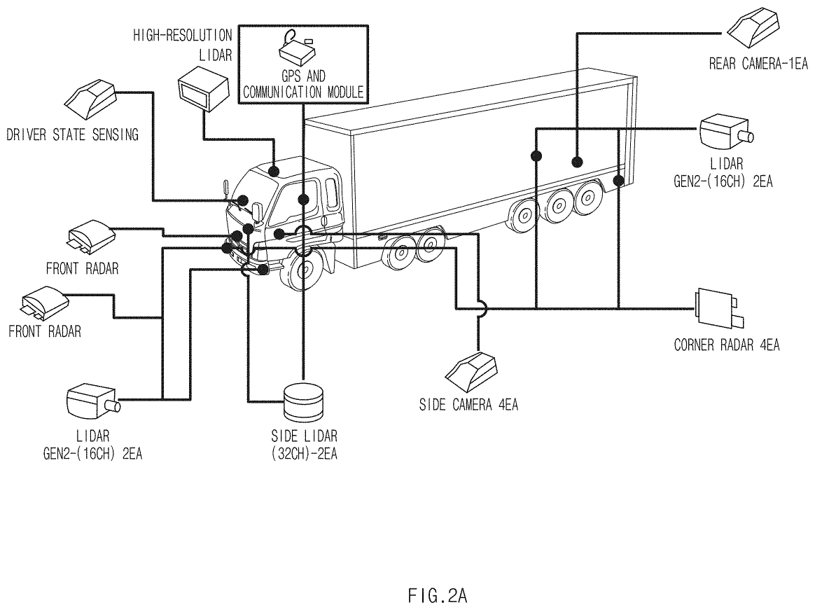

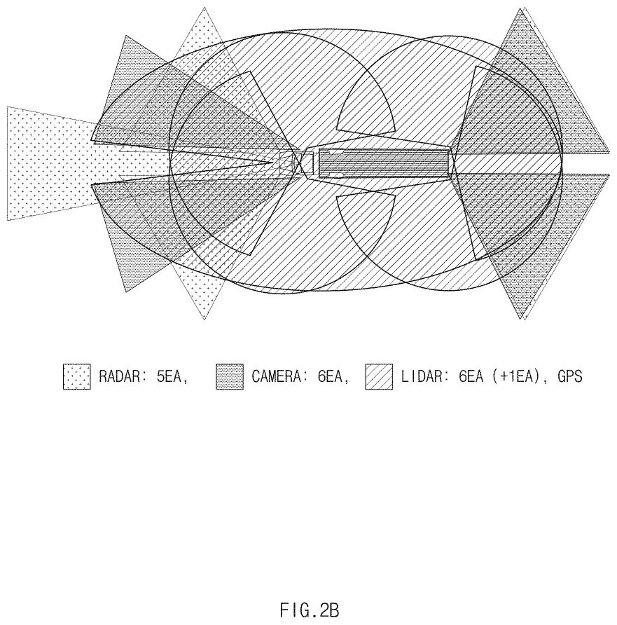

FIG. 2A illustrates a view for describing a sensing device of an autonomous vehicle according to various exemplary embodiments of the present invention, and FIG. 2B illustrates a sensing range of a sensing device of an autonomous vehicle according to various exemplary embodiments of the present invention.

Referring to FIG. 2A, the sensing device 120 may include a front radar mounted on the front of the vehicle, a Light Detection and Ranging (LiDAR), a side LiDAR, a side camera, a corner radar, a high-resolution LiDAR, a rear camera, a rear LiDAR, etc. Furthermore, referring to FIG. 2B, a surrounding situation may be detected through radars, cameras, and LiDARs of the front, rear, and side of the vehicle.

The steering control device 130 may be configured to control a steering angle of a vehicle, and may include a steering wheel, an actuator interlocked with the steering wheel, and a controller configured for controlling the actuator.

The braking control device 140 may be configured to control braking of the vehicle, and may include a controller that is configured to control a brake thereof.

The engine control device (ECU) 150 may be configured to control engine driving of a vehicle, and may include a controller that is configured to control a speed of the vehicle.

When receiving a remote control request from the autonomous vehicle 100, the control system 200 may generate a remote control path for the remote control and determine whether the remote control path is drivable based on a previous driving history of the remote control path, and when it is drivable, transmit the remote control path to the autonomous driving vehicle 100 and transmit a remote control command to the autonomous vehicle 100.

The control system 200 may include a communication device 211, a storage 212, an interface device 213, and a processor 214.

The communication device 211 is a hardware device implemented with various electronic circuits to transmit and receive signals through a wireless or wired connection, and may transmit and receive information based on in-vehicle devices and in-vehicle network communication techniques. As an example, the in-vehicle network communication techniques may include controller area network (CAN) communication, Local Interconnect Network (LIN) communication, flex-ray communication, Ethernet communication, and the like.

Furthermore, the communication device 211 may perform communication by use of a server, infrastructure, or third vehicles outside the vehicle, and the like through a wireless Internet technique or short range communication technique. Herein, the wireless Internet technique may include wireless LAN (WLAN), wireless broadband (Wibro), Wi-Fi, Worldwide Interoperability for Microwave Access (WiMAX), etc. Furthermore, short-range communication technique may include Bluetooth, ZigBee, ultra wideband (UWB), radio frequency identification (RFID), infrared data association (IrDA), and the like. For example, the communication device 211 may perform wireless communication with the vehicle 100, may receive a remote control request from the vehicle 100, and may transmit a consent request for the remote control path and a remote control command.

The storage 212 may store information received from the vehicle 100, and data and/or algorithm required for the processor 214 to operate, and the like.

As an example, the storage 212 may store a vehicle path received from the vehicle 100, image data photographed through a camera, a remote control path, a remote control command selected by an operator, and the like.

The storage 212 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 213 may include an input means configured for receiving a control command from an operator and an output means for outputting an operation state of the control system 200 and results thereof. Herein, the input means may include a key button, and may further include a mouse, a keyboard, a touch screen, a microphone, a joystick, a jog shuttle, a stylus pen, and the like. Furthermore, the input means may further include a soft key implemented on the display. For example, the interface device 213 may display map information in which a driving path of the vehicle, a current position of the vehicle, information related to surrounding objects, etc. are marked based on vehicle data received from the vehicle 100. For example, the interface device may include all communication terminals such as a personal computer (PC), a notebook computer, a smartphone, a tablet PC, a pad, a personal digital assistant (PDA), and a wearable device.

The output means may include a display, and may further include a voice output means such as a speaker. In the instant case, when a touch sensor formed of a touch film, a touch sheet, or a touch pad is provided on the display, the display may operate as a touch screen, and may be implemented in a form in which an input device and an output device are integrated.

In the instant case, the display may include at least one of a liquid crystal display (LCD), a thin film transistor liquid crystal display (TFT LCD), an organic light emitting diode display (OLED display), a flexible display, a field emission display (FED), or a 3D display.

The processor 214 may be electrically connected to the communication device 211, the storage 212, the interface device 213, and the like, may electrically control each component, and may be an electrical circuit that executes software commands, performing various data processing and determinations described below.

The processor 214 may process a signal transferred between components of the control system 200, and may perform overall control such that each of the components can perform its function normally. The processor 214 may be implemented in a form of hardware, software, or a combination of hardware and software, or may be implemented as microprocessor.

When receiving a remote control request from the autonomous vehicle 100, the processor 214 may generate a remote control path for remote control, and may determine whether the remote control path is drivable based on a previous driving history of the remote control path. When determining that the remote control path is drivable because there is the previous driving history of the remote control path, the processor 214 may transmit the remote control path to the autonomous vehicle 100, and may transmit the remote control command for the remote control request to the autonomous vehicle 100 in real time. In the instant case, the remote control command may include right turn, left turn, straight forward, and the like.

When receiving the remote control request from the autonomous vehicle 100, the processor 214 may generate the remote control path based on the information received from the autonomous vehicle 100.

The processor 214 may determine whether there is a history of driving a vehicle on a road on the remote control path or a road surrounding the remote control path. In the instant case, the processor 214 may collect driving histories of the road on the remote control path and the surrounding roads of the remote control path in advance from vehicles to store them in the storage device 212.

That is, the processor 214 may collect driving histories through all vehicles, road infrastructure, and traffic centers in advance to store them in the storage device 212. When there is a driving history of the road on the remote control path on which a vehicle has previously driven, the processor 214 may determine whether there is a history of the vehicle driving in a same direction as a driving direction on the remote control path. When there is a history of the vehicle driving in the same direction as the driving direction on the remote control path, the processor 214 may determine that the remote control path is a drivable road, and may determine the remote control path as a final remote control path, to transmit the remote control path to the autonomous vehicle 100.

On the other hand, when there is no history of the vehicle driving in the same direction as the driving direction on the remote control path, i.e., when there is a history of the vehicle driving in an opposite direction to the driving direction on the remote control path, the processor 214 may determine whether a vehicle speed of the vehicle driving in the opposite direction is equal to or greater than a predetermined reference value.

Accordingly, when the vehicle speed of the vehicle driving in the opposite direction is equal to or greater than the predetermined reference value, the processor 214 may request the autonomous vehicle 100 to consent to the remote control path.

Accordingly, when a consent request for the remote control path is received from the autonomous vehicle 100, the processor 214 may determine the remote control path as a final remote control path to transmit the remote control path to the autonomous vehicle 100.

On the other hand, when the vehicle speed of the vehicle driving in the opposite direction to the driving direction of the remote control path is smaller than the predetermined reference value, the processor 214 may determine that the road of the remote control path is drivable as a narrow road such as an alleyway, may determine the remote control path as a final remote control path, and may transmit the remote control path to the autonomous vehicle 100.

Furthermore, when the vehicle speed of the vehicle driving in the opposite direction to the driving direction of the remote control path is greater than or equal to the predetermined reference value, the processor 214 may request approval for the remote control path to an expert such as a control center or a traffic center instead of the autonomous vehicle 100, and may receive the approval.

Thereafter, the processor 214 may generate a remote control command based on information received when the remote control is requested from the autonomous vehicle 100, and may transmit the remote control command to the autonomous vehicle 100 in real time.

Accordingly, the control system 200 in various exemplary embodiments of the present invention may determine whether the remote control path is actually drivable by use of previous driving histories of other vehicles even when generating the remote control path, and when there is no driving histories of other vehicles, may minimize an error of the remote control command by requesting consent of the driver of the autonomous vehicle and performing the determination again.

Furthermore, the control system 200 in various exemplary embodiments of the present invention may transmit the verified final remote control path to the autonomous vehicle 100, and in the instant case, may determine the error of the remote control command by facilitating the autonomous vehicle 100 to compare the remote control command and the remote control path by transmitting a remote control command corresponding to the remote control request to the autonomous vehicle 100 in real time, and may minimize the error in remote control command by determining whether to perform the remote control command.

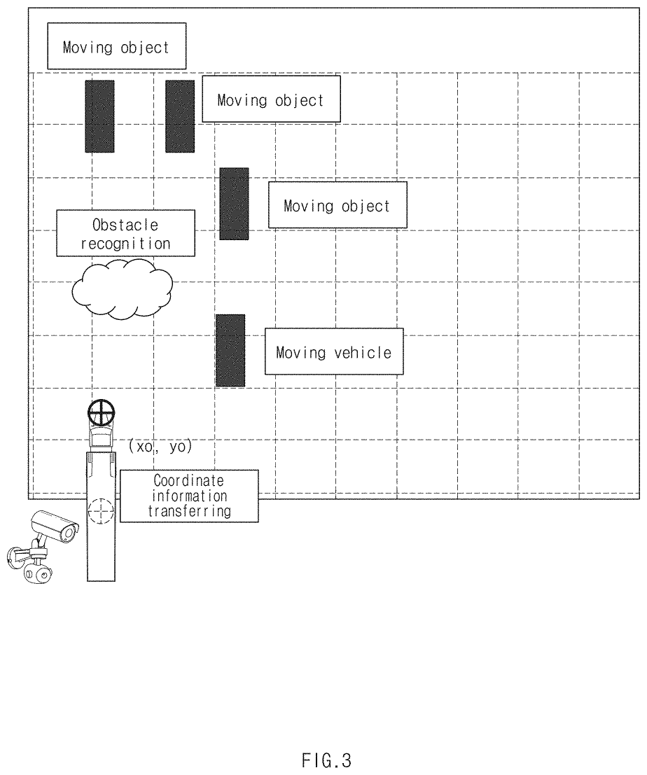

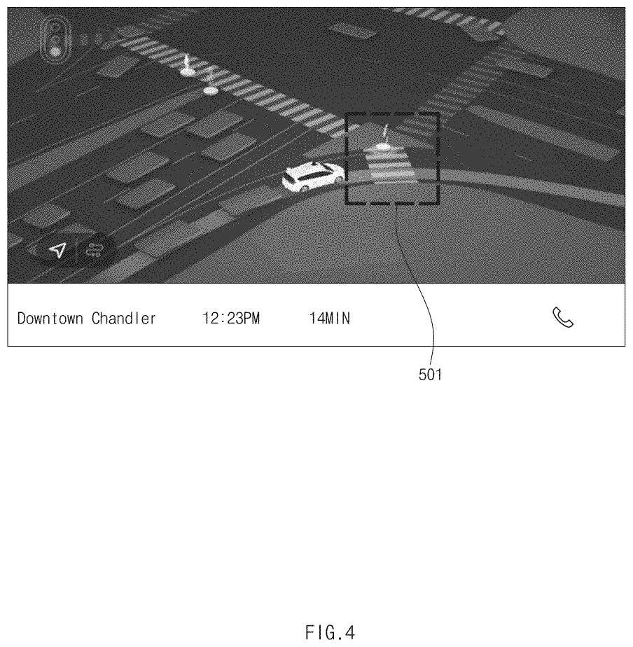

FIG. 3 illustrates a view for describing a process of determining whether to request remote control of an autonomous vehicle according to various exemplary embodiments of the present invention, and FIG. 4 illustrates a view for describing an example of a screen which is displayed in a control system based on information received from an autonomous vehicle according to various exemplary embodiments of the present invention.

Referring to FIG. 3, the vehicle 100 may transmit vehicle position information (e.g., vehicle coordinates), image information around the vehicle, information around the vehicle (e.g., an obstacle, a moving vehicle, a stationary vehicle, or a fixed object), map information, and/or the like to the control system 200.

Accordingly, the control system 200 may construct and display a 3D screen as shown in FIG. 4 based on the vehicle position information, the image information around the vehicle, and the information around the vehicle, received from the vehicle 100, to enable an operator to grasp a situation at a glance. In FIG. 4, a point 501 where a recognition error occurred is illustrated.

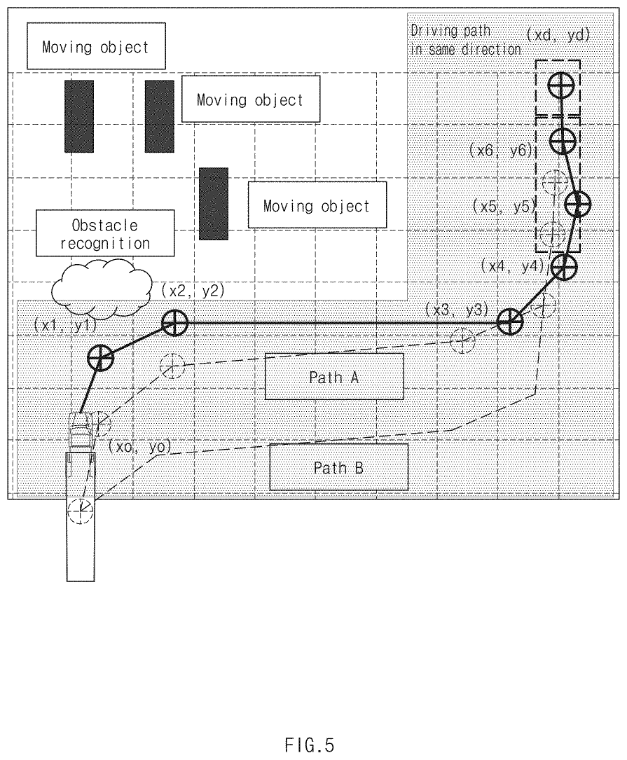

FIG. 5 illustrates an example of a screen showing a remote control path generated by a control system according to various exemplary embodiments of the present invention.

Referring to FIG. 5, when receiving a remote control request from the vehicle 100, the control system 200 may generate a remote control path configured for avoiding an obstacle to enable it to continue autonomous driving by avoiding the obstacle. In the instant case, the control system 200 generates a remote control path based on vehicle data received from the vehicle 100, and compares the remote control path with driving data of a surrounding road at a current position of the vehicle 100. In the instant case, the driving data of the surrounding road may include a driving history (path) on a surrounding road at a current position of the other vehicle 100 as well as a host vehicle, and the control system 200 may collect and store driving data of a surrounding road in advance through wireless communication with a vehicle driving on the surrounding road or infrastructure around the surrounding road.

The control system 200 may determine whether the remote control path exists within a driving range of the surrounding road. That is, the drivable range of the surrounding road indicates a range of a drivable road, and the control system 200 may determine that the surrounding road is drivable when there is a history of driving by another vehicle and a driving direction of the corresponding road matches a driving direction of the remote control path. For example, when a road A, a road B, and a road C exist around the vehicle 100, the control system 200 inquires whether there is a history of vehicles driving on the road A, road B, and road C.

For example, when there are histories of the road A and the road B on which other vehicles have driven, and no history of driving on the road C, the road C is not included in the drivable range. Furthermore, even when there are the driving histories of the road A and the road B, the control system 200 may determine whether a driving history in a same direction as a driving direction of the remote control path exists. Accordingly, in the case where the remote control path is in an upward direction on the road A, when there is a driving history of another vehicle in the upward direction of the road A, the control system 200 may determine that the remote control path is drivable.

In the instant case, the control system 200 may determine that the remote control path includes the C road, and when there is no history of driving the C road, the C road is a one-way road, has a barrier, or is not a road. In the instant case, when remotely controlling the vehicle 100, the control system 200 checks whether the vehicle has a history of driving on the road on the corresponding path to check whether the actual remote control path is a drivable path.

In the instant case, when the remote control path is within the drivable range of the surrounding road, e.g., when the remote control path is in an upward direction of the road B, and the upward direction of the road B is within the drivable range, the control system 200 may immediately approve the remote control path, and may transmit the remote control path to the vehicle 100.

On the other hand, when the remote control path does not exist within the drivable range of the surrounding road, e.g., when the remote control path is in the upward direction of the road B, but there is no driving history in the upward direction of the road B and there is a driving history in a downward direction, the control system 200 determines whether an average speed of the vehicle driving in the downward direction of the road B (reversed with respect to the host vehicle) is greater than or equal to a predetermined reference value (e.g., 43 km/h).

When the average speed of the vehicle driving in the downward direction of the road B (reversed with respect to the host vehicle) is smaller than the predetermined reference value (e.g., 43 km/h), the control system 200 may determine the remote driving path as a final remote driving path by determining the road B as the drivable range such as an alleyway.

On the other hand, when the average speed of the vehicle driving in the downward direction of the road B (reversed with respect to the host vehicle) is greater than or equal to the predetermined reference value (e.g., 43 km/h), the control system 200 may request approval by transmitting the remote driving path to the vehicle 100 since it is not certain whether the path in the downward direction of the road B is drivable. This is because an operator of the control system 200 cannot directly see the corresponding road and thus cannot determine whether driving is possible, but a driver of the vehicle 100 can check whether the surrounding road is drivable, and thus the control system 200 requests approval to the driver.

Accordingly, when finally approved by the driver, the control system 200 may determine the remote driving path as the final remote driving path, and may notify the vehicle 100, so that the vehicle 100 may perform following and control thereof depending on the final remote driving path. In the instant case, the vehicle 100 may compare the remote control command received from the control system 200 with the final remote driving path to check whether the remote driving path generated by the control system 200 is correct. Accordingly, when the final remote driving path and the remote control command match each other, the vehicle 100 may perform the following and control depending on the remote control command.

The control system may check whether there is a driving history of another vehicle within a predetermined distance (within a vehicle position identification range) from a current position of the vehicle 100. For example, the control system 200 may check a driving history, i.e., a driving path of another vehicle on a road in a 100-meter radius from the current position of the vehicle 100 or on a road on the remote control path.

The control system 200 determines whether a position of the obstacle requested to be avoided from the vehicle 100 is the same as that of the obstacle to be avoided in the path pre-stored in the control system 200. That is, when the vehicle 100 recognizes an obstacle while driving, determines that autonomous driving control cannot be continued, and requests remote control to the control system 200, the vehicle 100 transmits obstacle recognition information to the control system 200 to request remote control. Accordingly, the control system 200 searches for a history of remote control near the current position of the vehicle 100 in the past, and when an existing path is stored, determines whether information (e.g., position, size, etc.) of an obstacle received from the vehicle 100 is the same as information related to an obstacle to be avoided in pre-stored path information.

When the position of the obstacle requested to be avoided from the vehicle 100 is the same as that of the obstacle to be avoided in the path pre-stored in the control system 200, the control system 200 determines whether there are no other obstacles on the pre-stored path and is currently in a drivable state. For example, the control system 200 may determine whether a pre-stored path is currently drivable by determining whether a road is under construction, a traffic accident occurs, or severe traffic congestion occurs.

Furthermore, the control system 200 may determine whether there is a moving object, i.e., a vehicle on the pre-stored path, and when there is a vehicle in the pre-stored path, may determine whether the vehicle is movable in the future. That is, the control system 200 may determine the vehicle 100 which is movable in the future when there is a history of movement of a vehicle existing in the pre-stored path while it is stopped.

The control system 200 enables the vehicle 100 to continuously perform autonomous driving depending on the previously stored driving path by transferring the pre-stored driving path to the vehicle 100 without a separate remote control when there is the same remote control history within the predetermined distance from the current position of the vehicle 100, there are no obstacles on the driving path stored in the previous remote control history, and an obstacle on the pre-stored driving path, e.g., the vehicle, is movable in the future although the obstacle on the pre-stored path exists.

Furthermore, when there is a plurality of remote control histories within a predetermined distance from the current position of the vehicle 100, the control system 200 may select a most recent driving path or a shortest driving path to provide it to the vehicle 100.

Furthermore, when there is a plurality of remote control histories within a predetermined distance from the current position of the vehicle 100, there is a plurality of paths, and driving times of the plurality of paths are the same, the control system 200 provides a driving path of a same vehicle type as that of the vehicle 100 requesting a current remote control with a highest priority to the vehicle 100.

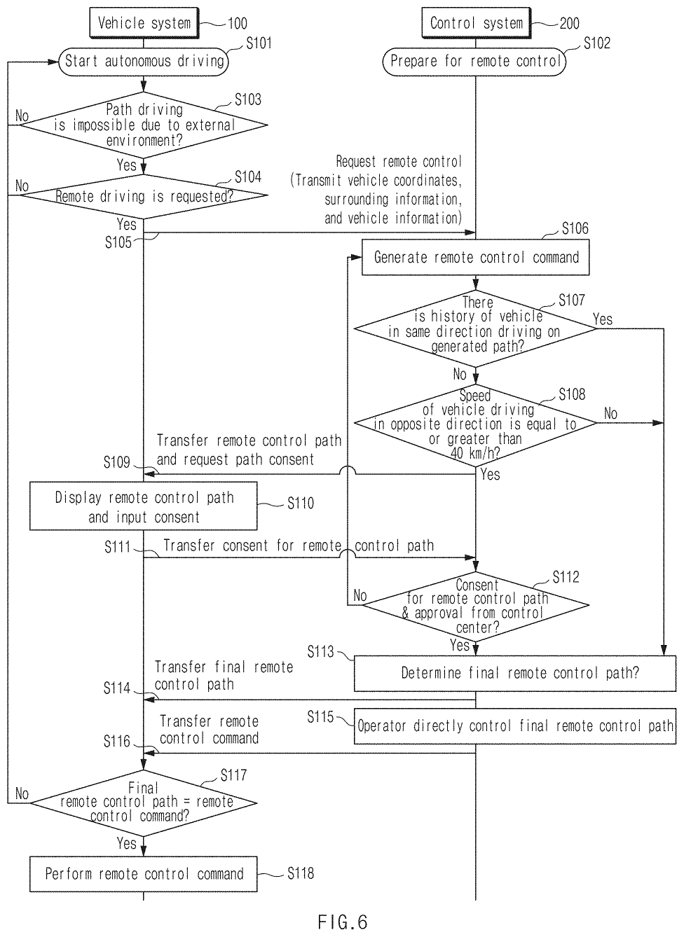

Hereinafter, a remote control method for an autonomous vehicle according to various exemplary embodiments of the present invention will be described in detail with reference to FIG. 6. FIG. 6 illustrates a flowchart showing a remote control method for an autonomous vehicle according to various exemplary embodiments of the present invention.

Hereinafter, it is assumed that the autonomous driving control apparatus 110 of the vehicle 100 of FIG. 1 and the control system 200 perform processes of FIG. 6. Furthermore, in the description of FIG. 6, it may be understood that operations referred to as being performed by each system are controlled by a processor of each of the systems.

Referring to FIG. 6, the vehicle 100 starts autonomous driving (S101), and the control system 200 prepares for remote control (S102).

The vehicle 100 determines whether driving of a current path is impossible due to an external environment during autonomous driving (S103), and when the driving of the current path is impossible, determines whether remote driving should be requested (S104). That is, the vehicle 100 may determine that the remote control is required when the vehicle cannot normally follow a path to a destination while driving in the autonomous driving mode. For example, as illustrated in FIG. 5, when an obstacle exists on the driving path, it may be determined that remote control is required.

Accordingly, when a remote driving request is required, the vehicle 100 performs a remote control request to the control system 200 (S105). In the instant case, the vehicle 100 transmits vehicle data such as vehicle position information (coordinates), vehicle surrounding information (surrounding object information the current changing the color of the etc.), and map information (current path of the vehicle) together therewith when requesting the remote control.

Accordingly, the control system 200 generates a remote control path for the remote control based on the vehicle data received from the vehicle 100 (S106). Accordingly, the control system 200 determines whether there is a history of a vehicle driving in a same direction as the remote control path (S107). That is, the control system 200 inquires whether there are previous histories of the corresponding remote control path on which other vehicles drive to determine whether the remote control path generated based on the vehicle data received from the vehicle 100 is a path that the vehicle can actually drive. Furthermore, when there are the previous histories of the corresponding remote control path on which other vehicles drive, the control system 200 may compare previous driving paths of other vehicles with the corresponding remote control path to determine whether other vehicles previously driven in a same direction as a driving direction of the corresponding remote control path or in an opposite direction thereto.

Accordingly, when there is a previous history of the remote control path on which another vehicle drives and there is a history of driving the other vehicle in the same driving direction as the driving direction of the remote control path, the control system 200 determines the corresponding remote control path as a final remote control path (S113). That is, when there is the history of driving the other vehicle in the same driving direction as the driving direction of the remote control path, the control system 200 determines that the remote control path is a drivable road to determine it as the final remote control path.

On the other hand, when there is previous history of the remote control path on which another vehicle drives but there is a history of driving the other vehicle in the opposite direction to the driving direction of the remote control path, the control system 200 determines whether a speed of the vehicle driving in the opposite direction is equal to or greater than a predetermined reference value (S108). When the speed of the vehicle driving in the opposite direction is equal to or greater than the predetermined reference value, it may be determined that the remote control path is a general road or highway, while when the speed of the vehicle driving in the opposite direction is smaller than the predetermined reference value, that is, when the vehicle is driving at a low speed, it may be determined that the remote control path is an alleyway. That is, the control system 200 may determine that reverse running is impossible when the remote control path is a general road or a highway, but reverse running is possible when the remote control path is an alleyway.

Accordingly, when the speed of the vehicle driving in the opposite direction is smaller than the predetermined reference value, the control system 200 determines the corresponding remote control path as the final remote control path (S113), and when the speed is greater than or equal to the predetermined reference value, transmits the remote control path to the vehicle 100 to request consent (S109). That is, since it is difficult for the control system 200 to determine whether the remote control path is an actual drivable road, the control system 200 directly requests consent to the driver of the vehicle 100 to determine whether the remote control path is a drivable road. The vehicle 100 may display the remote control path received from the control system 200 on a screen and display a consent request screen, so that the driver may input consent when the remote control path is a drivable path by checking the remote control path. For example, the vehicle 100 may receive the consent from the driver through a mouse, a keyboard, a touch screen, a microphone, or the like.

Accordingly, the vehicle 100 transmits the consent received from the driver to the control system 200 (S111).

The control system 200 checks whether consent is obtained from the vehicle 100 for the remote control path or approval for the remote control path is obtained from a control center (e.g., an expert) (S112), and when consent or approval for the remote control path is obtained from the vehicle 100 or the control center, the control system 200 determines the corresponding remote control path as the final remote control path (S113).

Accordingly, the control system 200 transmits the final remote control path to the vehicle 100 (S114), and transmits a remote control command for the operator to directly control the final remote driving path to the vehicle 100 (S116). In the instant case, the remote control command may include, e.g., changing a lane, ignoring an obstacle, and the like.

Next, the vehicle 100 stores the final remote control path received from the control system 200 and determines whether the remote control command transmitted from the control system 200 in real time matches the final remote control path (S117).

When the remote control command transmitted from the control system 200 in real time matches the final remote control path, the vehicle 100 continues autonomous driving control by executing the corresponding remote control command (S118), and when not match, performs the above-described steps S101 to S117 again.

Accordingly, the vehicle 100 may avoid obstacles in the autonomous driving mode depending on the remote control command received from the control system 200, and may transmit the remote control path to the control system 200 when the remote control is terminated.

Accordingly, an incorrect remote control command due to an operation mistake of the operator of the control system 200, etc. may be recognized by comparing the final remote control path and the remote control command received from the control system 200 in real time, to prevented a vehicle accident caused by the incorrect remote control command by controlling the incorrect remote control command to not performed.

Accordingly, according to various exemplary embodiments of the present invention, when the vehicle 100 receives a remote control path from the control system 200 during autonomous driving, it is possible to minimize the occurrence of accidents caused by path errors due to an operation mistake of an operator of the control system 200 by determining a risk of the remote control path, securing reliability of remote control and improving commercialization of autonomous driving.

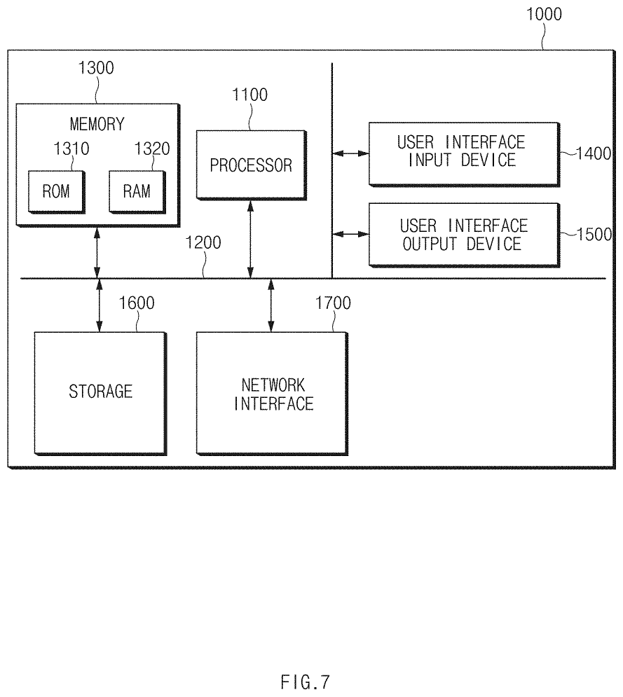

FIG. 7 illustrates a computing system according to various exemplary embodiments of the present invention.

Referring to FIG. 7, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media. For example, the memory 1300 may include a read only memory (ROM) 1310 and a random access memory (RAM) 1320.

Accordingly, steps of a method or algorithm described in connection with the exemplary embodiments included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, a EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of the present invention, and those skilled in the art to which various exemplary embodiments of the present invention pertains may make various modifications and variations without departing from the essential characteristics of the present invention.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. An autonomous vehicle comprising:
an autonomous driving control apparatus including a processor that is configured to request remote control of the autonomous vehicle to a control system when remote control of the autonomous vehicle is required, and when receiving a remote control path and a remote control command from the control system, to determine whether the remote control path matches the remote control command, and to perform the remote control command depending on a result thereof.

2. The autonomous vehicle of claim 1, wherein when receiving a consent request for the remote control path from the control system, the processor is configured to transmit consent for the remote control path to the control system.

3. The autonomous vehicle of claim 2, further including:
a display device configured to display the remote control path and a consent request screen for the remote control path.

4. The autonomous vehicle of claim 1, wherein the processor is configured to follow and control the remote control command when a path by the remote control command received from the control system matches the remote control path.

5. The autonomous vehicle of claim 1, wherein the processor is configured to request the remote control to the control system again without following and controlling the remote control command when the path by the remote control command received from the control system does not match the remote control path.

6. The autonomous vehicle of claim 1, wherein the processor is configured to transmit at least one of vehicle position information, vehicle surrounding image information, or vehicle surrounding information to the control system when requesting the remote control to the control system.

7. The autonomous vehicle of claim 1, further including:
a communication device configured to communicate with the control system; and
a storage configured to store the remote control path received from the control system.

8. A control system comprising:
a processor configured to generate a remote control path for remote control of an autonomous vehicle when receiving a remote control request from the autonomous vehicle, to determine whether the remote control path is drivable based on a previous driving history of the remote control path, and when the processor determines that the remote control path is drivable, to transmit the remote control path and a remote control command to the autonomous vehicle.

9. The control system of claim 8, wherein the processor is configured to generate the remote control path based on information received from the autonomous vehicle.

10. The control system of claim 8, wherein the processor is configured to determine whether there is a driving history of a road on the remote control path on which a vehicle has previously driven.

11. The control system of claim 10,
wherein the processor is configured to collect the driving history of the road on the remote control path and driving histories of surrounding roads of the remote control path in advance from the vehicle, and
wherein the control system further includes a storage configured to store the collected driving histories.

12. The control system of claim 11, wherein the processor is configured to determine whether there is a history of a vehicle driving in a same direction as a driving direction on the remote control path when there is the driving history of the road on the remote control path on which the vehicle has previously driven.

13. The control system of claim 12, wherein when there is the history of the vehicle driving in the same direction as the driving direction on the remote control path, the processor is configured to determine the remote control path as a final remote control path to transmit the remote control path to the autonomous vehicle.

14. The control system of claim 12, wherein when there is a history of a vehicle driving in an opposite direction to the driving direction on the remote control path, the processor is configured to determine whether a vehicle speed of the vehicle driving in the opposite direction is greater than or equal to a predetermined reference value.

15. The control system of claim 14, wherein when the vehicle speed of the vehicle driving in the opposite direction is greater than or equal to the predetermined reference value, the processor is configured to request consent for the remote control path to the autonomous vehicle.

16. The control system of claim 15, wherein when receiving a consent request for the remote control path from the autonomous vehicle, the processor is configured to determine the remote control path as a final remote control path to transmit the remote control path to the autonomous vehicle.

17. The control system of claim 14, wherein when the vehicle speed of the vehicle driving in the opposite direction is smaller than the predetermined reference value, the processor is configured to determine the remote control path as a final remote control path to transmit the remote control path to the autonomous vehicle.

18. The control system of claim 14, wherein when the vehicle speed of the vehicle driving in the opposite direction is greater than or equal to the predetermined reference value, the processor is configured to receive approval for the remote control path externally.

19. The control system of claim 14, wherein the processor is configured to generate a remote control command based on information received when receiving a remote control request from the autonomous vehicle to transmit the remote control command to the autonomous vehicle in real time.

20. A remote control method for an autonomous vehicle, the remote control method comprising:
receiving, by a control system, a remote control request from the autonomous vehicle;
generating, by the control system, a remote control path for the remote control request;
determining, by the control system, whether the remote control path is drivable based on a previous driving history of the remote control path;
transmitting, by the control system, the remote control path to the autonomous vehicle when the control system determines that the remote control path is drivable; and
generating, by the control system, a remote control command for the remote control request to transmit the remote control command to the autonomous vehicle.
